(19) United States
(12) Patent Application Publication
(10) Pub. No.: US 2008/0073563 A1
(43) Pub. Date: Mar. 27, 2008

(54) Exposure apparatus that includes a phase change circulation system for movers

(75) Inventors: W. Thomas Novak, Hillsborough, CA (US); Michael Binnard, Belmont, CA (US); Alex Ka Tim Poon, San Ramon, CA (US); Masahiro Totsu, Kumagaya (JP); Leonard Wai Fung Kho, San Francisco, CA (US); Gaurav Keswani, Fremont, CA (US)

Correspondence Address: Roeder & Broder LLP, 5560 Chelsea Avenue, La Jolla, CA, 92037, US

(73) Assignee: NIKON Corporation

(21) Appl. No.: 11/479,628

(22) Filed: Jul. 1, 2006

(51) Int. Cl. G01F 23/00

(52) U.S. Cl. 250/441.11

(57) ABSTRACT

A mover combination (226) for moving and positioning a device (34) includes a mover (328) that defines a fluid passageway (370) and a circulation system (330) having a passageway inlet (374) and a passageway outlet (376). The circulation system (330) directs a circulation fluid (378) into the fluid passageway (370). The circulation system (330) can include a liquid/gas separator (384) that is in fluid communication with the fluid passageway (370). With this design, the plumbing for the liquid (378A) and the gas (378B) can each be optimized. Additionally, the circulation system (330) can include a pressure control device (388) that controls the pressure of the circulation fluid (378) in at least a portion of the fluid passageway (370). With this design, the pressure control device (388) controls the pressure of the circulation fluid (378) near the fluid passageway (370) so that the temperature of the circulation fluid (378) at the passageway outlet (376) is approximately equal to the temperature of the circulation fluid (378) at the passageway inlet (374). Moreover, the circulation system (930) can include a pump assembly (980) that directs the circulation fluid (978) into the passageway inlet (974), and a pressure control device (996) that precisely controls a state of the circulation fluid (978) near the passageway inlet (974). With this design, the phase of the circulation fluid (978) at the passageway inlet (974) can be precisely controlled without restricting the flow of the circulation fluid (978).

### BACKGROUND

Lithography exposure apparatuses are commonly used to transfer images from a reticle onto a semiconductor wafer during semiconductor processing. A typical exposure apparatus includes an illumination source, a reticle stage assembly that positions a reticle, an optical assembly, a wafer stage assembly that positions a semiconductor wafer, and a measurement system. The size of the images and features within the images transferred onto the wafer from the reticle are extremely small. As a result thereof, the precise positioning of the wafer and the reticle is critical to the manufacture of high density, semiconductor wafers.

In certain apparatuses, the reticle stage assembly includes a reticle stage and one or more motors to precisely position the reticle. Similarly, the wafer stage assembly includes a wafer stage and one or more motors that precisely position the wafer. In order to obtain precise relative alignment, the position of the reticle and the wafer are constantly monitored by the measurement system. Subsequently, with the information from the measurement system, the reticle and/or wafer are moved by the motors.

Unfortunately, the electrical current supplied to the motors of the reticle stage assembly and the wafer stage assembly generate heat that is subsequently transferred to the surrounding environment. The heat changes the index of refraction of the surrounding air. This reduces the accuracy of the measurement system and degrades the positioning accuracy of the exposure apparatus. Further, the heat causes expansion of other components of the exposure apparatus. This can further degrade the accuracy of the exposure apparatus.

One solution to this problem includes surrounding the coils of each motor with a housing and directing a coolant through the housing to actively cool each motor. This type of motor can include an inlet through which coolant enters into the housing and an outlet from which the coolant exits the housing. With this design, heat from the coils is transferred to the coolant flowing through the housing.

Unfortunately, this type of arrangement is not entirely satisfactory. For example, because the heat from the coils is transferred to the coolant, the temperature of the coolant at the outlet is higher than the temperature of the coolant at the inlet. This temperature difference can influence the accuracy of the exposure apparatus. For example, the temperature difference can cause the air temperature to fluctuate and thus, reduce accuracy of the measurement system. Additionally, components near the motor can be thermally deformed.

### SUMMARY

The present invention is directed a mover combination that includes a mover and a circulation system. The mover includes a conductor array. Further, the mover defines a fluid passageway that is positioned near the conductor array. The fluid passageway includes a passageway inlet and a passageway outlet. The circulation system directs a circulation fluid into the fluid passageway. In one embodiment, the circulation system includes a separator that is in fluid communication with the fluid passageway. The separator separates gas from liquid. As provided herein, the separator can be positioned near the mover, and the separator can be secured to and move with the mover. With this design, in certain embodiments, gas and liquid are separated by the separator near the fluid passageway, and the plumbing for the liquid and the gas that exits the fluid passageway can each be optimized.

In certain embodiments, the circulation system directs the circulation fluid into the passageway inlet, and the circulation fluid is within approximately 1 degree Celsius of boiling at the passageway inlet. Further, in certain embodiments, heat from the mover that is transferred to the circulation fluid causes at least a portion of the circulation fluid that flows in the fluid passageway to change phase from liquid to gas.

In one embodiment, the circulation system includes a pressure control device that controls the pressure of the circulation fluid in at least a portion of the fluid passageway. More specifically, the pressure control device can control the pressure of the circulation fluid near the passageway outlet. With this design, the pressure control device can control the pressure of the circulation fluid near the passageway outlet so that the temperature of the circulation fluid at the passageway outlet is approximately equal to the temperature of the circulation fluid at the passageway inlet.

In another embodiment, the circulation system includes a pump assembly that directs the circulation fluid into the passageway inlet, and a pressure source that precisely controls the pressure at the passageway inlet to control the phase of the circulation fluid near the passageway inlet. In certain embodiments, the pressure source adjusts the pressure of the circulation fluid without restricting the flow of the circulation fluid and the pressure source is acting on a single-phase liquid.

The present invention is also directed to (i) an isolation system including the mover combination, (ii) a stage assembly including the mover combination, (iii) an exposure apparatus including the mover combination, and (iv) an object or wafer on which an image has been formed by the exposure apparatus. Further, the present invention is also directed to (i) a method for making a circulation system, (ii) a method for making a mover combination, (iii) a method for making a stage assembly, (iv) a method for manufacturing an exposure apparatus, and (v) a method for manufacturing an object or a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of an exposure apparatus having features of the present invention;

FIG. 2 is a perspective view of a mover having features of the present invention;

FIG. 3 is a simplified illustration of a first embodiment of the mover combination having features of the present invention;

FIG. 4 is a pressure-enthalpy diagram that illustrates temperature of a circulation fluid at a passageway inlet and a passageway outlet;

FIG. 5 is a simplified illustration of another embodiment of a mover combination having features of the present invention;

FIG. 6 is a simplified illustration of yet another embodiment of a mover combination having features of the present invention;

FIG. 7 is a simplified illustration of still another embodiment of a mover combination having features of the present invention;

FIG. 8 is a cut-away side view of a conductor assembly and a level maintainer having features of the present invention;

FIG. 9 is a schematic illustration of another embodiment of a mover combination having features of the present invention;

FIG. 10 is a partly cut-away perspective view of another embodiment of a conductor assembly having features of the present invention;

FIG. 11A is a flow chart that outlines a process for manufacturing a device in accordance with the present invention; and

FIG. 11B is a flow chart that outlines device processing in more detail.

### DESCRIPTION

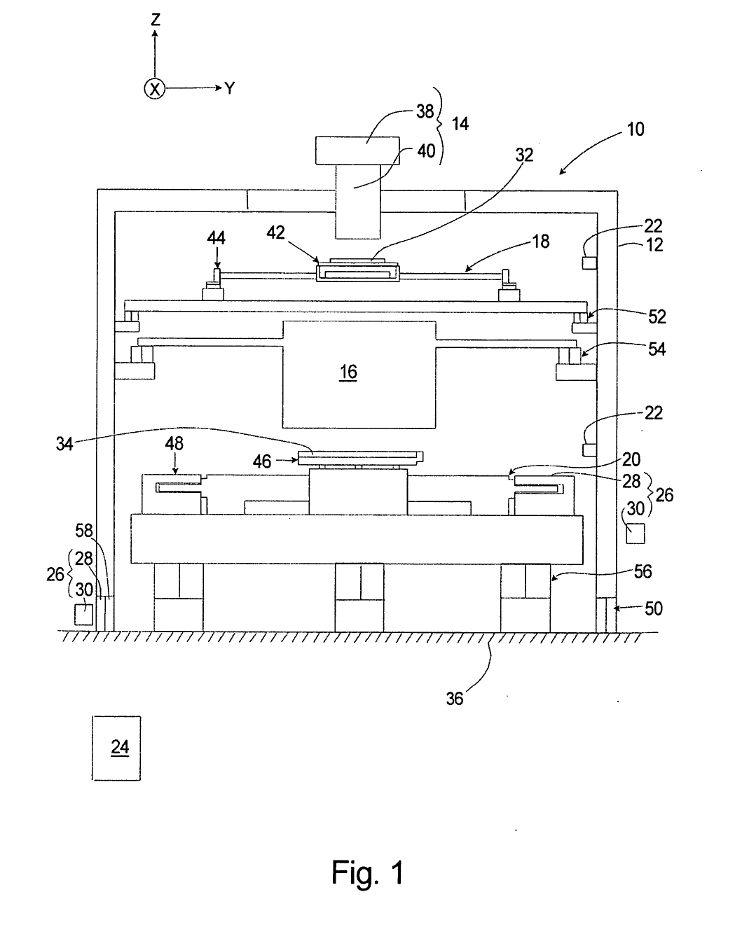

FIG. 1 is a schematic illustration of a precision assembly, namely an exposure apparatus 10 having features of the present invention. The exposure apparatus 10 includes an apparatus frame 12, an illumination system 14 (irradiation apparatus), an optical assembly 16, a reticle stage assembly 18, a wafer stage assembly 20, a measurement system 22, and a control system 24. The design of the components of the exposure apparatus 10 can be varied to suit the design requirements of the exposure apparatus 10.

As provided herein, one or both of the stage assemblies 18, 20 can include a mover combination 26 having one or more movers 28 and one or more circulation systems 30 (illustrated as a box in FIG. 1). In one embodiment, the circulation system 30 reduces the amount of heat transferred from one or more movers 28 to the surrounding environment. With this design, the movers 28 can be placed closer to the measurement system 22 and/or the influence of heat from the movers 28 on the accuracy of the measurement system 22 and the rest of the components of the exposure apparatus 10 is reduced. Further, the exposure apparatus 10 is capable of manufacturing higher precision devices, such as higher density, semiconductor wafers.

A number of Figures include an orientation system that illustrates an X axis, a Y axis that is orthogonal to the X axis and a Z axis that is orthogonal to the X and Y axes. It should be noted that these axes can also be referred to as the first, second and third axes.

The exposure apparatus 10 is particularly useful as a lithographic device that transfers a pattern (not shown) of an integrated circuit from a reticle 32 onto a semiconductor wafer 34. The exposure apparatus 10 mounts to a mounting base 36, e.g., the ground, a base, or floor or some other supporting structure.

There are a number of different types of lithographic devices. For example, the exposure apparatus 10 can be used as a scanning type photolithography system that exposes the pattern from the reticle 32 onto the wafer 34 with the reticle 32 and the wafer 34 moving synchronously. In a scanning type lithographic device, the reticle 32 is moved perpendicularly to an optical axis of the optical assembly 16 by the reticle stage assembly 18 and the wafer 34 is moved perpendicularly to the optical axis of the optical assembly 16 by the wafer stage assembly 20. Scanning of the reticle 32 and the wafer 34 occurs while the reticle 32 and the wafer 34 are moving synchronously.

Alternatively, the exposure apparatus 10 can be a step-and-repeat type photolithography system that exposes the reticle 32 while the reticle 32 and the wafer 34 are stationary. In the step and repeat process, the wafer 34 is in a constant position relative to the reticle 32 and the optical assembly 16 during the exposure of an individual field. Subsequently, between consecutive exposure steps, the wafer 34 is consecutively moved with the wafer stage assembly 20 perpendicularly to the optical axis of the optical assembly 16 so that the next field of the wafer 34 is brought into position relative to the optical assembly 16 and the reticle 32 for exposure. Following this process, the images on the reticle 32 are sequentially exposed onto the fields of the wafer 34, and then the next field of the wafer 34 is brought into position relative to the optical assembly 16 and the reticle 32.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern from a mask to a substrate with the mask located close to the substrate without the use of a lens assembly.

The apparatus frame 12 is rigid and supports the components of the exposure apparatus 10. The apparatus frame 12 illustrated in FIG. 1 supports the stage assemblies 18, 20, the optical assembly 16 and the illumination system 14 above the mounting base 30.

In one embodiment, the illumination system 14 includes an illumination source 38 and an illumination optical assembly 40. The illumination source 38 emits a beam (irradiation) of light energy. The illumination optical assembly 40 guides the beam of light energy from the illumination source 38 to the optical assembly 16. The beam illuminates selectively different portions of the reticle 32 and exposes the wafer 34. In FIG. 1, the illumination source 38 is illustrated as being supported above the reticle stage assembly 18. Typically, however, the illumination source 38 is secured to one of the sides of the apparatus frame 12 and the energy beam from the illumination source 38 is directed to above the reticle stage assembly 18 with the illumination optical assembly 40.

The illumination source 38 can be a g-line source (436 nm), an i-line source (365 nm), a KrF excimer laser (248 nm), an ArF excimer laser (193 nm) or a F₂ laser (157 nm). Alternatively, the illumination source 38 can generate charged particle beams such as an x-ray or an electron beam. For instance, in the case where an electron beam is used, thermionic emission type lanthanum hexaboride (LaB₆) or tantalum (Ta) can be used as a cathode for an electron gun. Furthermore, in the case where an electron beam is used, the structure could be such that either a mask is used or a pattern can be directly formed on a substrate without the use of a mask.

The optical assembly 16 projects and/or focuses the light passing through the reticle 32 to the wafer 34. Depending upon the design of the exposure apparatus 10, the optical assembly 16 can magnify or reduce the image illuminated on the reticle 32. The optical assembly 16 need not be limited to a reduction system. It could also be a 1× or magnification system.

When far ultra-violet rays such as the excimer laser is used, glass materials such as quartz and fluorite that transmit far ultra-violet rays can be used in the optical assembly 16. When the F₂ type laser or x-ray is used, the optical assembly 16 can be either catadioptric or refractive (a reticle should also preferably be a reflective type), and when an electron beam is used, electron optics can consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Patent Application No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 18 holds and positions the reticle 32 relative to the optical assembly 16 and the wafer 34. Somewhat similarly, the wafer stage assembly 20 holds and positions the wafer 34 with respect to the projected image of the illuminated portions of the reticle 32. The design of each stage assembly 18, 20 can be varied to suit the movement requirements of the exposure apparatus 10. In FIG. 1, the reticle stage assembly 18 includes a reticle stage 42 that retains the reticle 32 and a reticle mover assembly 44 that moves and positions the reticle stage 42 and the reticle 32 relative to the rest of the exposure apparatus 10. For example, the reticle mover assembly 44 can include one or more movers 28 and can be designed to move the reticle stage 42 with three degrees of movement. Alternatively, the reticle mover assembly 44 can be designed to move the reticle stage 42 with more than three or less than three degrees of freedom of movement.

Somewhat similarly, the wafer stage assembly 20 includes a wafer stage 46 that retains the wafer 34 and a wafer mover assembly 48 that moves and positions the wafer stage 46 and the wafer 34 relative to the rest of the exposure apparatus 10. For example, the wafer mover assembly 48 can include one or more movers 28 and can be designed to move the wafer stage 46 with three degrees of freedom of movement. Alternatively, the wafer mover assembly 48 can be designed to move the wafer stage 46 with more than three or less than three degrees of freedom of movement.

When linear motors (see U.S. Pat. Nos. 5,623,853 or 5,528,118) are used in a wafer stage or a mask stage, the linear motors can be either an air levitation type employing air bearings or a magnetic levitation type using Lorentz force or reactance force. As far as is permitted, the disclosures in U.S. Pat. Nos. 5,623,853 and 5,528,118 are incorporated herein by reference.

Alternatively, one or both of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically transferred to the floor (ground) by use of a frame member as described in U.S. Pat. No. 5,528,100 and published Japanese Patent Application Disclosure No. 8-136475. Additionally, reaction forces generated by the reticle (mask) stage motion can be mechanically transferred to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

The measurement system 22 monitors movement of (i) the reticle stage 42 and the reticle 32 relative to the optical assembly 16 or some other reference, and (ii) the wafer stage 46 and the wafer 34 relative to the optical assembly 16 or some other reference. With this information, the control system 24 can control the reticle stage assembly 18 to precisely position the reticle 32 and the wafer stage assembly 20 to precisely position the wafer 34. For example, the measurement system 22 can utilize multiple laser interferometers, encoders, and/or other measuring devices.

The control system 24 is electrically connected to the reticle stage assembly 18, the wafer stage assembly 20, the measurement system 22, and the one or more circulation systems 30. The control system 24 receives information from the measurement system 22 and controls the stage assemblies 18, 20 to precisely position the reticle 32 and the wafer 34. Further, the control system 24 controls the operation of the one or more circulation systems 30. The control system 24 can include one or more processors and circuits.

Additionally, the exposure apparatus 10 can include one or more isolation systems that include a mover combination 26 having features of the present invention. For example, in FIG. 1, the exposure apparatus 10 includes (i) a frame isolation system 50 that secures the apparatus frame 12 to the mounting base 36 and reduces the effect of vibration of the mounting base 36 causing vibration to the apparatus frame 12, (ii) a reticle stage isolation system 52 that secures and supports the reticle stage assembly 18 to the apparatus frame 12 and reduces the effect of vibration of the apparatus frame 12 causing vibration to the reticle stage assembly 18, (iii) an optical isolation system 54 that secures and supports the optical assembly 16 to the apparatus frame 12 and reduces the effect of vibration of the apparatus frame 12 causing vibration to the optical assembly 16, and (iv) a wafer stage isolation system 56 that secures and supports the wafer stage assembly 20 to the mounting base 36 and reduces the effect of vibration of the mounting base 36 causing vibration to the wafer stage assembly 20. In this embodiment, each isolation system 50-56 can include (i) one or more pneumatic cylinders 58 that isolate vibration, and/or (ii) one or more mover combinations 26 made pursuant to the present invention that isolate vibration and control the position of the respective apparatus.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. There is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

This invention can be utilized in an immersion type exposure apparatus with taking suitable measures for a liquid. For example, PCT Patent Application WO 99/49504 discloses an exposure apparatus in which a liquid is supplied to the space between a substrate (wafer) and a projection lens system in exposure process. As far as is permitted, the disclosures in WO 99/49504 are incorporated herein by reference.

Further, this invention can be utilized in an exposure apparatus that comprises two or more substrate and/or reticle stages. In such apparatus, the additional stage may be used in parallel or preparatory steps while the other stage is being used for exposing. Such a multiple stage exposure apparatus are described, for example, in Japan Patent Application Disclosure No. 10-163099 as well as Japan Patent Application Disclosure No. 10-214783 and its counterparts U.S. Pat. No. 6,341,007, No. 6,400,441, No. 6,549,269, and No. 6,590,634. Also it is described in Japan Patent Application Disclosure No. 2000-505958 and its counterparts U.S. Pat. No. 5,969,411 as well as U.S. Pat. No. 6,208,407. As far as is permitted, the disclosures in the above-mentioned U.S. Patents, as well as the Japan Patent Applications, are incorporated herein by reference.

This invention can be utilized in an exposure apparatus that has a movable stage retaining a substrate (wafer) for exposing it, and a stage having various sensors or measurement tools for measuring, as described in Japan Patent Application Disclosure 11-135400. As far as is permitted, the disclosures in the above-mentioned Japan patent application are incorporated herein by reference.

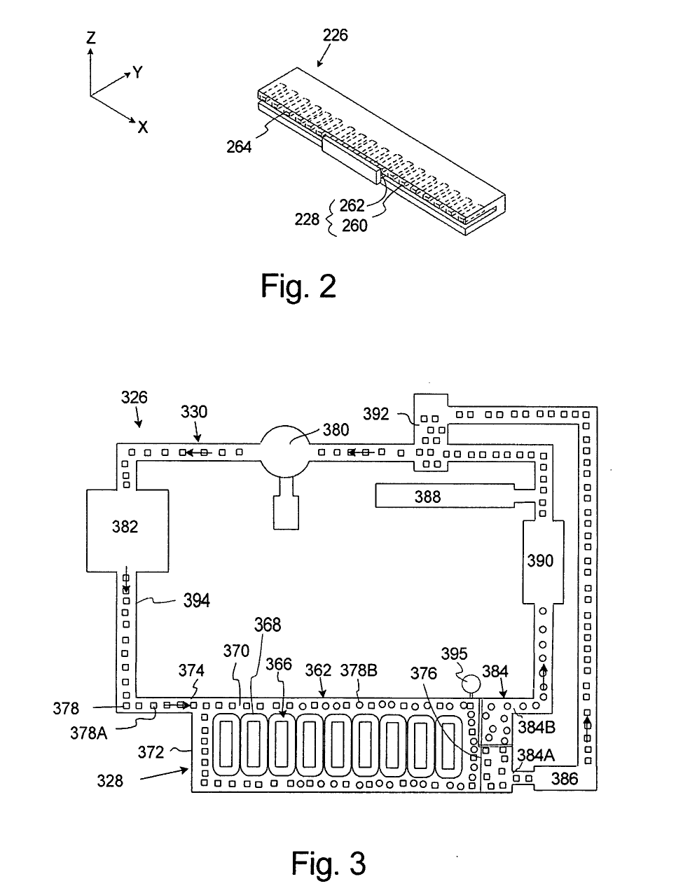

FIG. 2 is a perspective view of a mover 228 that can be used as part of a mover combination 226 in (i) one or both of the mover assemblies 44, 48 (illustrated in FIG. 1), (ii) one or all of the isolation systems 50-56 (illustrated in FIG. 1), or (iii) other types of devices during manufacturing and/or inspection. The design of the mover 228 can be varied to suit the movement requirements of the apparatus. In one embodiment, the mover 228 includes a magnet component 260 and a conductor component 262 that interacts with the magnet component 260. In FIG. 2, the conductor component 262 moves relative to the stationary magnet component 260. Alternatively, for example, the mover 228 could be designed so that the magnet component 260 moves relative to a stationary conductor component 262.

In FIG. 2, the mover 228 is a linear motor and the conductor component 262 moves linearly along the X axis relative to the magnet component 260. Alternatively, for example, the mover 228 can be a rotary motor, voice coil motor, electromagnetic mover, planar motor, or some other type of force mover.

The magnet component 260 includes one or more spaced apart magnet arrays 264 (illustrated in phantom). For example, in FIG. 2, the magnet component 260 includes two spaced apart magnet arrays 264 (only the upper magnet array is illustrated in FIG. 2). Each magnet array 264 can include one or more magnets.

FIG. 3 is a simplified illustration of a first embodiment of the mover combination 326 that can be used in (i) one or both of the mover assemblies 44, 48 (illustrated in FIG. 1), (ii) one or all of the isolation systems 50-56 (illustrated in FIG. 1), or (iii) other types of devices during manufacturing and/or inspection. In FIG. 3, the conductor component 362 of the mover 328 is illustrated in more detail. In one embodiment, the conductor component 362 includes a conductor array 366 having one or more conductors 368 that are aligned along an axis.

Additionally, the mover 328 defines a fluid passageway 370 that can be used to cool and/or control the temperature of the conductor array 366 or another portion of the mover 328. The design and location of the fluid passageway 370 can be varied to achieve the desired cooling requirements of the mover 328. In one embodiment, the fluid passageway 370 is positioned near the conductor array 366. In FIG. 3, the conductor component 362 includes a somewhat rectangular tube shaped circulation housing 372 that encircles the conductor array 366. With this design, the space between the circulation housing 372 and the conductor array 366 defines the fluid passageway 370 that encircles the conductor array 366, and the fluid passageway 370 moves concurrently with the conductor array 366. Alternatively, the circulation housing 372 can have another shape and/or the fluid passageway 370 could be at least partly or fully encircled by the conductor array 366. Still alternatively, for example, the fluid passageway 370 could be secured to the magnet component 260 (illustrated in FIG. 2) and the conductor array 366 could move relative to the fluid passageway 370.

As provided herein, the fluid passageway 370 includes one or more passageway inlets 374 and one or more passageway outlets 376 that are in fluid communication with the circulation system 330. With this design, in certain embodiments, the circulation system 330 directs a circulation fluid 378 into the fluid passageway 370 via the one or more passageway inlets 374, and the circulation fluid 378 that passes through the fluid passageway 370 exits the one or more passageway outlets 376 to the circulation system 330. It should be noted that the location of the passageway inlet(s) 374 and/or passageway outlet(s) 376 can be varied to influence the cooling of the conductor array 366. In the embodiment illustrated in FIG. 3, a single passageway inlet 374 is positioned on one end of the conductor array 366 and a single passageway outlet 376 is positioned on the opposite end of the conductor array 366. Alternatively, for example, one passageway inlet 374 can be located near the center of the conductor array 366 and passageway outlets 376 can be located near the opposite ends of the conductor array 366, or one passageway outlet 376 can be located near the center of the conductor array 366 and passageway inlets 374 can be located near the opposite ends of the conductor array 366.

In certain embodiments, the circulation system 330 can be used to maintain a portion of the entire outer surface of the mover 328 at a set temperature, and/or to reduce the amount of heat transferred from the mover 328 to the surrounding environment. This reduces the influence of the mover 328 on the temperature of the environment surrounding the mover 328 and allows for more accurate positioning by the mover 328.

The design of the circulation system 330 can vary. In one embodiment, the circulation fluid 378 can be used to cool the conductor component 362 without increasing the temperature of the circulation fluid 378 by using latent heat based on changes in a state of the circulation fluid 378. In certain embodiments, the circulation system 330 controls the temperature of the circulation fluid 378 at or near the passageway inlet 374 and the pressure of the circulation fluid 378 at or near the passageway outlet 376 so that (i) the circulation fluid 378 is primarily a liquid 378A (illustrated as small squares) at the passageway inlet 374, and (ii) the temperature of the circulation fluid 378 at the passageway outlet 376 is approximately equal to the temperature of the circulation fluid 378 at the passageway inlet 374. In alternative, non-exclusive embodiments, the circulation system 330 controls the temperature and pressure of the circulation fluid 378 so that at least approximately 95, 97, 98, 99 or 100 percent of the circulation fluid 378 is a liquid 378A at the passageway inlet 374. Further, the circulation system 330 controls the temperature and pressure of the circulation fluid 378 so that the circulation fluid 378 is near the boiling point without boiling at the passageway inlet 374. For example, in alternative, non-exclusive embodiments, the circulation system 330 controls the temperature and pressure of the circulation fluid 378 so that the circulation fluid 378 is within approximately 2, 1, 0.8, 0.6, 0.5, 0.4, 0.3, 0.2, or 0.1 degrees Celsius of the boiling temperature of the circulation fluid 378 at the absolute pressure at the passageway inlet 374. Moreover, the pressure control device 388 controls the pressure of the circulation fluid 378 near the passageway outlet 376 so that the temperature of the circulation fluid 378 at the passageway outlet 376 is within approximately 1, 0.8, 0.6, 0.5, 0.4, 0.3, 0.2, or 0.1 degrees Celsius of the temperature of the circulation fluid 378 at the passageway inlet 374.

Additionally, as detailed below, at least a portion of the circulation fluid 378 undergoes a phase change during movement through the fluid passageway 370. In one embodiment, at least a portion of the circulation fluid 378 changes phase from a liquid 378A to a gas 378B (illustrated as small circles) during movement through the fluid passageway 370.

In one embodiment, the circulation fluid 378 is a substantially inactive (e.g., inert) fluid. For example, hydrofluoroether (e.g., “Novec HFE”: manufactured by 3M, Minneapolis, Minn.), a fluoride system inactive liquid (e.g., “Flourinert” manufactured by 3M, Minneapolis, Minn.), or the like, can be used or water also can be used as a circulation substance.

In FIG. 3, the circulation system 330 includes a pump assembly 380, a temperature adjusting device 382, a separator 384, a level maintainer 386, a pressure control device 388, a condenser 390, and a reservoir 392. The design, shape, orientation, and/or positioning of these components can be varied to achieve the cooling requirements of the circulation system 330. Further, in certain embodiments, the circulation system 330 can include fewer components than detailed above. For example, the circulation system 330 can be designed without the level maintainer 386. It should be noted that the circulation system 330 can include additional components that are not illustrated in FIG. 3. For example, the circulation system 330 can include flow meters, flow valves, temperature measurers, relief valves, and/or pressure gauges.

It should also be noted that one or more of the components of the circulation system 330 can be controlled by the control system 24 (illustrated in FIG. 1) to precisely control the temperature of the outer surface of the mover 328 and the surrounding environment. Moreover, one or more fluid conduits 394 can connect the components of the circulation system 330 in fluid communication.

The pump assembly 380 moves the circulation fluid 378 through the circulation system 330 and the fluid passageway 370. In FIG. 3, the pump assembly 380 includes a pump and a motor that drives the pump. The rate at which the pump assembly 380 directs the circulation fluid 378 to the fluid passageway 370 can be varied to suit the cooling requirements of the mover 328.

The temperature adjusting device 382 adjusts the temperature of the circulation fluid 378 in the circulation system 330. In FIG. 3, the temperature adjusting device 382 adjusts the temperature of the circulation fluid 378 to precisely control the temperature of the circulation fluid 378 at or near the passageway inlet 374 to the fluid passageway 370. The temperature adjusting device 382 can include a heater and/or a chiller. In one embodiment, the temperature adjusting device 382 is a thermoelectric heat exchanger. In FIG. 3, an inlet to the temperature adjusting device 382 is in fluid communication with an outlet of the pump assembly 380 and an outlet of the temperature adjusting device 382 is in fluid communication with the passageway inlet 374 of the fluid passageway 370.

The separator 384 separates gas 378B from the liquid 378A of the circulation fluid 378. With the use of the separator 384, only the gas 378B is directed to the condenser 390. As a result thereof, in certain embodiments, the plumbing for the liquid 378A and the gas 378B that exits the fluid passageway 370 can each be optimized.

The design and location of the separator 384 can be varied to achieve the requirements of the circulation system 330. Suitable gas/liquid separators 384 include a chamber with two outlet ports, namely a vapor remove port and liquid remove port, the vapor remove port being physically at a higher location than the liquid remove port. In this embodiment, the working of the separator is based on using gravity to separate lighter vapor from heavier liquid drops. The vapor which is lighter rises into the upper portion of the chamber and the liquid which is heavier will be on the lower portion of the chamber.

In one embodiment, the separator 384 is secured to the conductor component 362 and moves with the conductor component 362. In FIG. 3, the separator 384 is positioned adjacent to and near the passageway outlet 376, and the passageway outlet 376 is in direct fluid communication with the inlet of the separator 384. Further, in FIG. 3, the separator 384 includes a liquid outlet 384A that is in fluid communication with the reservoir 392 via the level maintainer 386, and a gas outlet 384B that is in fluid communication with an inlet to the pressure control device 388.

Alternatively, the separator 384 can be spaced apart from the conductor component 362 and/or the conductor component 362 can move relative to the separator 384. In this design, the passageway outlet 376 is still in fluid communication with the inlet of the separator 382.

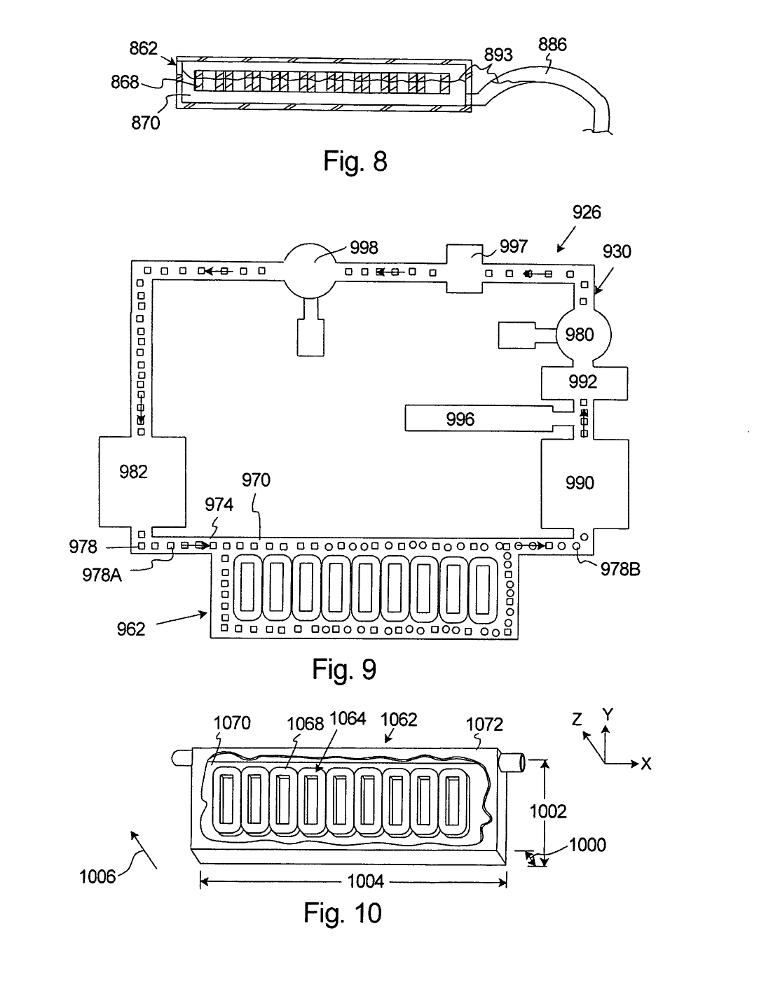

The level maintainer 386 maintains a predetermined level of liquid 378A within the fluid passageway 370. With this design, in certain embodiments, the level maintainer 386 ensures that all of the conductors 368 are at least partly submerged with the liquid 378A. A suitable level maintainer 386 is illustrated in FIG. 8 and described below. In FIG. 3, an inlet to the level maintainer 386 is in fluid communication with the liquid outlet 384A of the separator 382. Alternatively, for example, the inlet to the level maintainer 386 can be directly connected to the passageway outlet 376.

The pressure control device 388 precisely controls the pressure of the circulation fluid 378 in at least a portion of the fluid passageway 370 to precisely control the temperature of the circulation fluid 378 at or near the passageway outlet 376. In certain embodiments, the pressure control device 388 precisely controls the pressure of the circulation fluid 378 at or near the passageway outlet 376. With this design, the pressure control device 388 can adjust the pressure of the circulation fluid 378 at or near the passageway outlet 376 so that the temperature of the circulation fluid 378 at the passageway outlet 376 is approximately equal to the temperature of the circulation fluid 378 at the passageway inlet 374. With this design, the circulation fluid 378 can be used to maintain the mover 328 at a set temperature without increasing the temperature of the circulation fluid 378, and the influence of heat from the mover 328 on the surrounding environment is significantly reduced.

Alternatively, for example, the pressure control device 388 can be used to adjust the pressure of the circulation fluid 378 at or near the passageway outlet 376 so that the temperature of the circulation fluid 378 at the passageway outlet 376 is a predetermined amount (e.g. 1 degree Celsius) different than the temperature of the circulation fluid 378 at the passageway inlet 374.

Non-exclusive examples of suitable pressure control devices 388 can include an electronic regulator, a pump, or a variable volume chambers (e.g. bellows). The amount of pressure change that the pressure control device 388 makes on the circulation fluid 378 can be varied according to the type of circulation fluid 378, the design of the mover 328, and the design of the rest of the circulation system 330. In alternative, non-exclusive embodiments, the pressure control device 388 reduces the pressure of the circulation fluid 378 approximately 0.5, 1, 2, 3, 4, or 5 PSI.

The pressure control device 388 can be controlled either in an open-loop fashion or by using closed loop feedback control. The feedback can be from a temperature or pressure sensor 395 positioned at the point where temperature is to be regulated.

In FIG. 3, the pressure control device 388 is connected to the outlet of the condenser 390. Alternatively, for example, if the separator 384 is spaced apart from the passageway outlet 376, the pressure control device 388 can be connected to passageway outlet 376 between the passageway outlet 376 and the inlet to the separator 384. Still alternatively, the pressure control device 388 can be connected between the separator 384 and the condenser 390.

The condenser 390 receives the gas 378B from the separator 384 and condenses that gas 378B into liquid 378A with minimum deviation from the desired inlet temperature and is then transferred to the reservoir 392. In one embodiment, an inlet to the condenser 390 is in fluid communication with the gas outlet 384B of the separator 384. With this design, any gas 378B that leaves the separator 384 is condensed into liquid 378A. In one embodiment, the condenser 390 includes a heat exchanger that condenses the gas 378B into liquid 378A.

The reservoir 392 receives the liquid 378A from the separator 384 and the liquid 378A from the condenser 390. In one embodiment, a first inlet to the reservoir 392 is in fluid communication with the fluid exit of the level maintainer 386, and a second inlet to the reservoir 392 is in fluid communication with the exit of the condenser 390 via the pressure control device 388.

The operation of the circulation system 330 can be further explained with reference to FIG. 3. In this embodiment, the circulation fluid 378 is supplied to the passageway inlet 374 as a liquid 378A near its boiling point and flows in the fluid passageway 370. The circulation fluid 378 flows along the conductors 368, during which time, heat is transferred from the conductors 368 to the circulation fluid 378 to cool the conductors 368. With this design, a portion of the circulation fluid 378 is gradually changed to gas 378B (i.e., its state changes from liquid to gas) by the transfer of heat from the conductors 368 to the circulation fluid 378. Stated in another fashion, during movement of the circulation fluid 378 in the fluid passageway 370, the circulation fluid 378 absorbs the heat of the conductors 368 and at least a portion of the circulation fluid 378 changes from a liquid 378A state to a gas 378B state. The conductors 368 are cooled due to the absorption of heat that occurs due to the change in the state of the circulation fluid 378. In certain embodiments, the temperature of the circulation fluid 378 does not increase while cooling the conductors 368.

As illustrated in FIG. 3, the amount of liquid 378A contained in the circulation fluid 378 at the passageway inlet 374 is greater that the amount of liquid 378A contained in the circulation fluid 378 at the passageway outlet 376. This is because a portion of the liquid 378A has changed phase into gas 378B as it flows through the fluid passageway 370. With the present design, in one non-exclusive embodiments, the percentage of liquid 378A contained in the circulation fluid 378 at the passageway inlet 374 is approximately 100 percent, the percentage of volume of liquid 378A contained in the circulation fluid 378 at the passageway outlet 376 is between approximately 1 and 50 percent, and the percentage of gas 378B contained in the circulation fluid 378 at the passageway outlet 376 is between approximately 50 and 99 percent.

It should be noted that the pressure of the circulation fluid 378 will change as the heat from the conductors 368 is transferred to the circulation fluid 378 and the circulation fluid 378 moves across the conductors 368. The pressure control device 388 can be used to compensate for the pressure change and to achieve the desired temperature of the circulation fluid 378 at the passageway outlet 376.

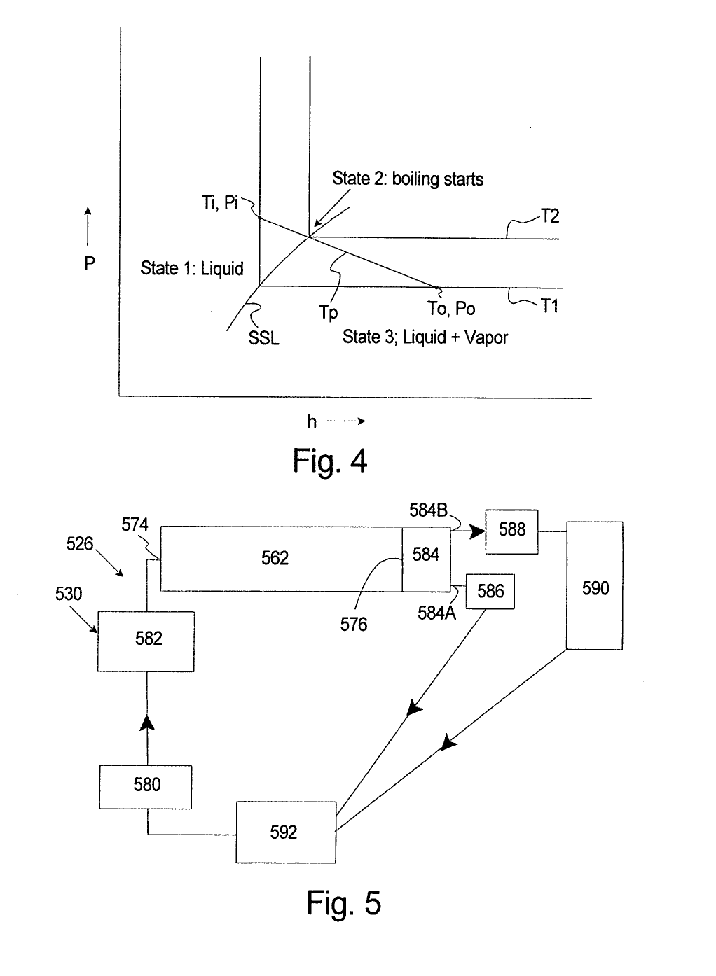

FIG. 4 is a pressure-enthalpy diagram that includes a line Tp that represents the temperature of the circulation fluid 378 (illustrated in FIG. 3) as the circulation fluid 378 moves through the fluid passageway 370 (illustrated in FIG. 3). In FIG. 4, (i) line T1 represents a constant first temperature, (ii) line T2 represents a constant second temperature that is greater than the first temperature T1, and (iii) curved line SLL represents the saturated liquid line. On one side of the line SLL, the circulation fluid 378 is a liquid, and on the other side of line SLL, the circulation fluid 378 is a mixture of liquid and gas.

The left end of line Tp illustrates the inlet temperature Ti and the inlet pressure Pi of the circulation fluid 378 at the passageway inlet 374 (illustrated in FIG. 3), and the right end of line Tp illustrates the outlet temperature To and the outlet pressure Po of the circulation fluid 378 at the passageway outlet 376 (illustrated in FIG. 3). As described above, the circulation system 330 (illustrated in FIG. 3) controls the inlet temperature Ti near the passageway inlet 374 and the outlet pressure Po near the passageway outlet 376. In this embodiment, when the circulation fluid 378 enters the passageway inlet 374, the circulation fluid 378 is entirely in the liquid phase (state 1 at Ti) and the inlet temperature Ti is equal to the first temperature T1. Further, as the circulation fluid 378 flows in the fluid passageway 370, there is a pressure drop because of flow in the fluid passageway 370 (pressure drops from state 1 to state 3). Moreover, at the passageway outlet 376, the outlet pressure (Po) is regulated with the pressure control device 388 (illustrated in FIG. 3) so that the circulation fluid 378 boils at the desired temperature (pressure at state 3 is regulated to boiling pressure at temperature T1) so that the outlet temperature To is equal to T1 and Ti.

Stated in another fashion, as the circulation fluid 378 moves from the passageway inlet 374, the circulation fluid 378 first gains sensible heat from the conductors 368 (illustrated in FIG. 3) and the temperature of the circulation fluid 378 rises (from state 1 to state-2: T1 to T2). At the point where temperature reaches the boiling point corresponding to pressure at that point, the liquid is saturated and starts boiling (state 2). From this state, as the circulation fluid 378 moves over the conductors 368, it absorbs latent heat of vaporization and is converted into gas (state2-state3; mixed phase flow). In this region, the temperature drops by a small amount corresponding to pressure drop in flow. This mixed phase (liquid+vapor in state 3) circulation fluid 378 reaches the separator 384 (illustrated in FIG. 3) at the passageway outlet 376.

It should be noted that the inlet temperature Ti and the outlet temperature To are approximately equal to T1. However there is a slight variation in temperature in between Ti and To. More specifically, there is a slow rise in the temperature from state 1 to state 2 and a subsequent small drop in the temperature from state 2 to state 3. In certain embodiments, this temperature variation can be reduced by reducing the pressure drop from state 1 to state 2, and/or state 2 to state 3, leading to constant temperature heat removal from mover. Additionally, the appropriate choice of circulation fluid 378 can also help to reduce the variation in temperature.

Alternatively, the temperature variation can be reduced by either (i) adjusting the inlet temperature Ti to be different from desired mover temperature, (ii) adjusting the outlet pressure Po so that the liquid boils at a temperature different from desired mover temperature, (iii) by the appropriate design of the fluid passageway 370, (iv) by the appropriate design of the circulation system 330, and/or (iv) by using a combination of (i)-(iv).

FIG. 5 is a simplified illustration of another embodiment of a mover combination 526 that can be used in (i) one or both of the mover assemblies 44, 48 (illustrated in FIG. 1,) (ii) one or all of the isolation systems 50-56 (illustrated in FIG. 1), or (iii) other types of devices during manufacturing and/or inspection. In this embodiment, the conductor component 562 is similar to the corresponding component described above and illustrated in FIG. 3. Further, the circulation system 530 includes a pump assembly 580, a temperature adjusting device 582, a separator 584, a level maintainer 586, a pressure control device 588, a condenser 590, and a reservoir 592 that operate somewhat similar to the corresponding components described above and illustrated in FIG. 3. However, in this embodiment, the circulation system 530 is designed to operate at sub-atmospheric pressures and the pressure control device 588 is a vacuum source that is connected to the gas outlet 584B of the separator 584 via the condenser 590.

In this embodiment, the pressure control device 588 is positioned between the separator 584 and the condenser 590. Further, the pressure control device 588 can be controlled to obtain similar functions as described in the previous embodiments.

In another embodiment, the amount of liquid supplied to the passageway inlet 574 can be regulated such that substantially all of the liquid is converted into gas at the passageway outlet 576. The gas coming out of the passageway outlet 576 may be saturated or superheated depending on temperature distribution requirements. With this design, the circulation system 530 can be designed without the separator 584 and a liquid outlet 584A.

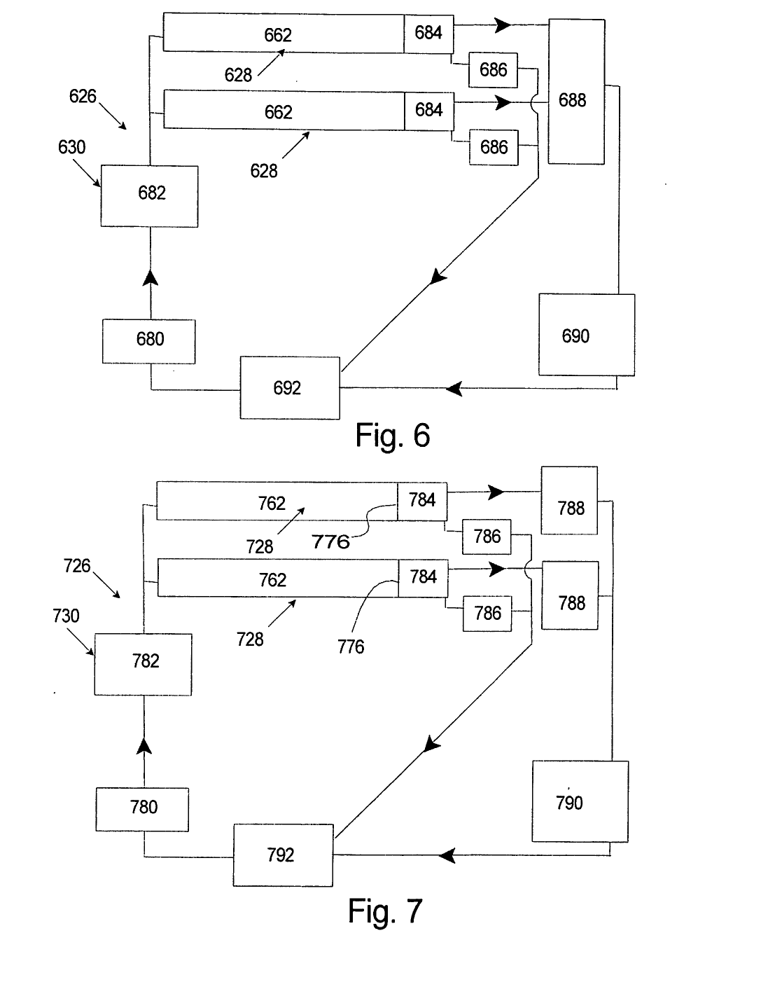

FIG. 6 is a simplified illustration of yet another embodiment of a mover combination 626 that can be used in (i) one or both of the mover assemblies 44, 48 (illustrated in FIG. 1,) (ii) one or all of the isolation systems 50-56 (illustrated in FIG. 1), or (iii) other types of devices during manufacturing and/or inspection. In this embodiment, the mover combination 626 includes two conductor components 662 (two separate movers) that are each similar to the corresponding component described above and illustrated in FIG. 3.

In this embodiment, the circulation system 630 includes a pump assembly 680, a temperature adjusting device 682, a pair of separators 684, a pair of level maintainers 686, a pressure control device 688, a condenser 690, and a reservoir 692 that are somewhat similar to the corresponding components described above and illustrated in FIG. 3. However, in this embodiment, circulation system 630 is designed to have the capacity to control the temperature of two separate movers 628. Stated in another fashion, the circulation system 630 can be extended to include capacity to control the surface temperatures of multiple movers 628 by sharing common components. In this embodiment, the circulation system 630 controls the movers 628 to be at approximately the same temperature.

FIG. 7 is a simplified illustration of still another embodiment of a mover combination 726 that can be used in (i) one or both of the mover assemblies 44, 48 (illustrated in FIG. 1,) (ii) one or all of the isolation systems 50-56 (illustrated in FIG. 1), or (iii) other types of devices during manufacturing and/or inspection. In this embodiment, the mover combination 726 includes two conductor components 762 (two separate movers) that are each similar to the corresponding component described above and illustrated in FIG. 3.

In this embodiment, the circulation system 730 includes a pump assembly 780, a temperature adjusting device 782, a pair of separators 784, a pair of level maintainers 786, a pair of pressure control devices 788, a condenser 790, and a reservoir 792 that are somewhat similar to the corresponding components described above and illustrated in FIG. 3. Again, in this embodiment, circulation system 730 is designed to have the capacity to control the temperature of two movers 728. However, in this embodiment, the circulation system 730 can control the temperature of movers 728 that each have a different temperature control requirement. More specifically, the separate pressure control devices 788 allow the circulation system 730 to control the pressure near the passageway outlet 776 for each mover 728. With this design, the pressure can be individually controlled to control the temperature of the circulation fluid in the respective fluid passageway.

FIG. 8 is a cut-away side view of a conductor component 862 and one embodiment of a level maintainer 886 that can be used in any of the circulation systems described herein. In this embodiment, the level maintainer 886 maintains a predetermined level 893 of liquid within the fluid passageway 870. With this design, in certain embodiments, the level maintainer 886 ensures that all of the conductors 868 are at least partly submerged with the liquid. In FIG. 8, the separator is not illustrated. In this embodiment, the level maintainer 886 is an inverted “U” shaped tube section. With this design, the top of the inverted “U” shape maintains the level 893 of the circulation fluid in the fluid passageway 870.

FIG. 9 is a schematic illustration of another embodiment of a mover combination 926 that can be used in (i) one or both of the mover assemblies 44, 48 (illustrated in FIG. 1,) (ii) one or all of the isolation systems 50-56 (illustrated in FIG. 1), or (iii) other types of devices during manufacturing and/or inspection. In this embodiment, the conductor component 962 is similar to the corresponding component described above and illustrated in FIG. 3.

In this embodiment, the circulation system 930 includes a pump assembly 980, a temperature adjusting device 982, a condenser 990, and a reservoir 992 that are somewhat similar to the corresponding components described above and illustrated in FIG. 3. However, in this embodiment, the circulation system 930 includes a pressure control device 996 that precisely controls the inlet pressure of the circulation fluid 978 so that the circulation fluid 978 is primarily a liquid 978A (illustrated as small squares) at the passageway inlet 974.

In alternative, non-exclusive embodiments, the circulation system 930 controls the temperature and pressure of the circulation fluid 978 at the passageway inlet 974 so that at least approximately 95, 98, 99 or 100 percent of the circulation fluid 978 is a liquid 978A. Further, at least a portion of the circulation fluid 978 undergoes a phase change during movement through the fluid passageway 970. More specifically, at least a portion of the circulation fluid 978 changes from a liquid 978A to a gas 978B (illustrated as small circles) during movement through the fluid passageway 970.

In FIG. 9, the circulation system 930 also includes a flow meter 997 that measures the flow of the circulation fluid 978, and a flow valve assembly 998 that can be used to selectively adjust the flow of the circulation fluid 978.

Moreover, in FIG. 9, the circulation system 930 can include the separator and/or the level maintainer. Further, one or more of the components can be controlled by the control system 24 (illustrated in FIG. 1).

In this embodiment, the pressure control device 996 precisely adjusts the pressure of the circulation fluid 978, precisely controls the fluid state of the circulation fluid 978 at the passageway inlet 974, and brings the system to equilibrium with the proper fluid state at the passageway inlet 974. The temperature adjusting device precisely controls the temperature of fluid at inlet. Further, in one embodiment, the pressure control device 996 is at a location between the exit of the condenser 990 and the entrance to the reservoir assembly 980. With this design, the pressure control device 996 is acting on a single-phase circulation fluid 978.

The amount of pressure change that the pressure control device 996 makes on the circulation fluid 978 can be varied to achieve the desired fluid state of the circulation fluid 978. In alternative, non-exclusive embodiments, the pressure control device 996 decreases the pressure of the circulation fluid 978 at the passageway inlet 974 at least approximately 0.5, 1, 2, 3, 4, or 5 PSI. Stated another way, in alternative, non-exclusive embodiments, the pressure control device 996 decreases the pressure of the circulation fluid 978 at the passageway inlet 974 between approximately 0 and 1, 0 and 2, or 0 and 5 PSI.

FIG. 10 is a partly cut-away perspective view of another embodiment of a conductor component 1062, including the circulation housing 1072 and the conductors 1068 in more detail. In FIG. 10, the conductors 1068 are aligned along the X axis. In this embodiment, the fluid passageway 1070 includes a passageway height 1000 that is aligned with the height of the conductors 1068 along the Z axis, a passageway width 1002 that is aligned with the conductors 1068 along the Y axis, and a passageway length 1004 that is aligned with the plurality of conductors 1068 along the X axis.

In one embodiment, the passageway height 1000 is less than the passageway width 1002 and the passageway length 1004. Further, in one embodiment, the smallest dimension of the fluid passageway 1070 is positioned vertically and aligned with and coaxial with the force of gravity 1006, and the greatest dimension of the fluid passageway 1070 is positioned horizontally. In FIG. 10, the passageway height 1000 is aligned with the force of gravity 1006. In certain designs, the density gradient in the circulation fluid (not shown in FIG. 10) along the Z axis is enough to inhibit boiling at the bottom of the fluid passageway 1070. With this design, because the smallest dimension is coaxial with gravity, there is more uniform boiling of the circulation fluid in the fluid passageway 1070. Thus, a horizontally oriented conductor array 1064 will have more uniform boiling and will remove more heat by the phase change of the circulation fluid.

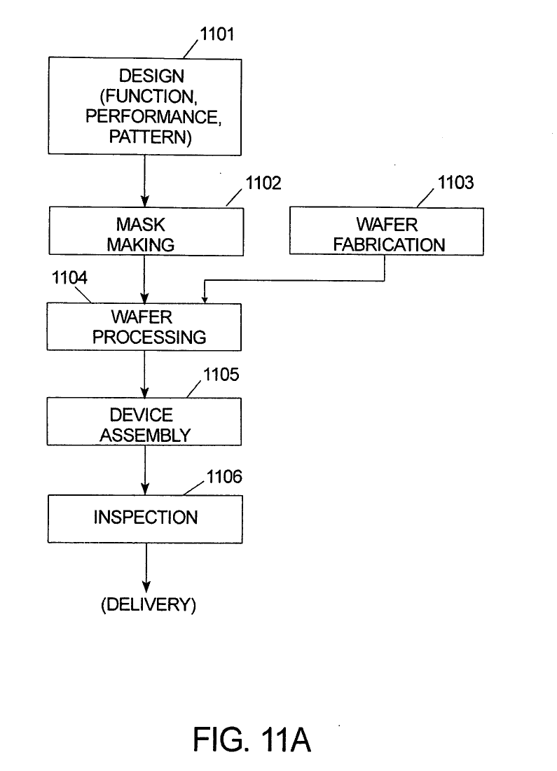

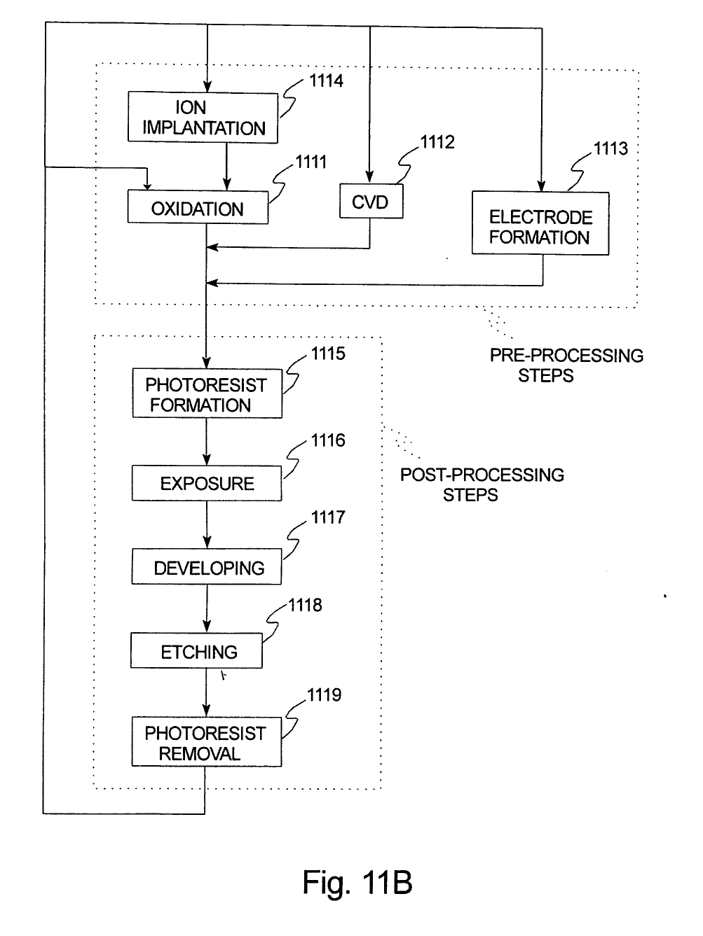

Semiconductor devices can be fabricated using the above described systems, by the process shown generally in FIG. 11A. In step 1101 the device's function and performance characteristics are designed. Next, in step 1102, a mask (reticle) having a pattern is designed according to the previous designing step, and in a parallel step 1103 a wafer is made from a silicon material. The mask pattern designed in step 1102 is exposed onto the wafer from step 1103 in step 1104 by a photolithography system described hereinabove in accordance with the present invention. In step 1105, the semiconductor device is assembled (including the dicing process, bonding process and packaging process), finally, the device is then inspected in step 1106.

FIG. 11B illustrates a detailed flowchart example of the above-mentioned step 1104 in the case of fabricating semiconductor devices. In FIG. 11B, in step 1111 (oxidation step), the wafer surface is oxidized. In step 1112 (CVD step), an insulation film is formed on the wafer surface. In step 1113 (electrode formation step), electrodes are formed on the wafer by vapor deposition. In step 1114 (ion implantation step), ions are implanted in the wafer. The above mentioned steps 1111-1114 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 1115 (photoresist formation step), photoresist is applied to a wafer. Next, in step 1116 (exposure step), the above-mentioned exposure device is used to transfer the circuit pattern of a mask (reticle) to a wafer. Then in step 1117 (developing step), the exposed wafer is developed, and in step 1118 (etching step), parts other than residual photoresist (exposed material surface) are removed by etching. In step 1119 (photoresist removal step), unnecessary photoresist remaining after etching is removed. Multiple circuit patterns are formed by repetition of these preprocessing and post-processing steps.

While the current invention is disclosed in detail herein, it is to be understood that it is merely illustrative of the presently preferred embodiments of the invention and that no limitations are intended to the details of construction or design herein shown other than as described in the appended claims.

What is claimed is:

1. A mover combination comprising:
a mover including a conductor, the mover defining a fluid passageway that is positioned near the conductor; and
a circulation system that directs a circulation fluid into the fluid passageway, the circulation system including a separator that is in fluid communication with the fluid passageway, the separator separating gas from liquid.

2. The mover combination of claim 1 wherein the separator is positioned near the mover.

3. The mover combination of claim 1 wherein the separator is secured to and moves with the mover.

4. The mover combination of claim 1 wherein the circulation system directs the circulation fluid to a passageway inlet of the fluid passageway, and wherein the circulation fluid is within approximately 1 degree Celsius of boiling at the passageway inlet.

5. The mover combination of claim 1 wherein at least a portion of the circulation fluid that flows in the fluid passageway changes phase from liquid to gas.

6. The mover combination of claim 5 wherein the fluid passageway includes a passageway inlet that receives the circulation fluid from the circulation system and a passageway outlet, and wherein the temperature of the circulation fluid at the passageway outlet is approximately equal to the temperature of the circulation fluid at the passageway inlet.

7. The mover combination of claim 1 wherein the circulation system includes a pressure control device that controls the pressure of the circulation fluid in at least a portion of the fluid passageway.

8. The mover combination of claim 7 wherein the fluid passageway includes a passageway inlet that receives the circulation fluid from the circulation system and a passageway outlet, and wherein the pressure control device controls the pressure of the circulation fluid near the passageway outlet.

9. The mover combination of claim 8 wherein the pressure control device controls the pressure of the circulation fluid so that the temperature of the circulation fluid at the passageway outlet is approximately equal to the temperature of the circulation fluid at the passageway inlet.

10. The mover combination of claim 9 wherein the pressure control device controls the pressure of the circulation fluid so that the temperature of the circulation fluid at the passageway outlet is within approximately 1 degrees Celsius of the temperature of the circulation fluid at the passageway inlet.

11. The mover combination of claim 1 wherein the fluid passageway includes a passageway inlet; and the circulation system includes a pump assembly that directs the circulation fluid into the passageway inlet, and a pressure source that precisely controls a state of the circulation fluid near the passageway inlet.

12. The mover combination of claim 1 further comprising a level maintainer that maintains a predetermined level of liquid in the fluid passageway.

13. An isolation system including the mover combination of claim 1.

14. A stage assembly including the mover combination of claim 1.

15. An exposure apparatus including the mover combination of claim 1.

16. A method for manufacturing an object, the method comprising the steps of providing a substrate, and transferring an image to the substrate with the exposure apparatus of claim 15.

17. A mover combination comprising:
a mover including a conductor, the mover defining a fluid passageway that is positioned near the conductor; and
a circulation system that directs a circulation fluid into a passageway inlet of the fluid passageway, the circulation system including a pressure control device that controls the pressure of the circulation fluid near a passageway outlet of the fluid passageway.

18. The mover combination of claim 17 wherein the pressure control device controls the pressure of the circulation fluid near the passageway outlet so that the temperature of the circulation fluid at the passageway outlet is approximately equal to the temperature of the circulation fluid at the passageway inlet.

19. The mover combination of claim 18 wherein the pressure control device controls the pressure of the circulation fluid near the passageway outlet so that the temperature of the circulation fluid at the passageway outlet is within approximately 1 degrees Celsius of the temperature of the circulation fluid at the passageway inlet.

20. The mover combination of claim 17 wherein the circulation system including a separator that is in fluid communication with the fluid passageway, the separator separating gas from liquid, the separator being positioned near the mover.

21. The mover combination of claim 17 wherein the circulation fluid is within approximately 1 degree C. of boiling at the passageway inlet.

22. The mover combination of claim 17 wherein at least a portion of the circulation fluid that flows in the fluid passageway changes phase from liquid to gas.

23. The mover combination of claim 17 further comprising a level maintainer that maintains a predetermined level of liquid in the fluid passageway.

24. An isolation system including the mover combination of claim 17.

25. A stage assembly including the mover combination of claim 17.

26. An exposure apparatus including the mover combination of claim 17.

27. A method of cooling a mover, the mover including a conductor and a fluid passageway that is positioned near the conductor, the method comprising the steps of:
directing a circulation fluid into a passageway inlet to the fluid passageway; and
connecting a separator in fluid communication with a passageway outlet of the fluid passageway, the separator separating gas from liquid contained in the circulation fluid.

28. The method of claim 27 wherein the step of directing a circulation fluid includes the step of directing a circulation fluid that is within approximately 1 degree Celsius of boiling at the passageway inlet.

29. The method of claim 27 further comprising the step of controlling the pressure of the circulation fluid near a passageway outlet of the fluid passageway with a pressure control device.

30. The method of claim 27 further comprising the step of controlling the pressure of the circulation fluid near a passageway outlet of the fluid passageway with a pressure control device so that the temperature of the circulation fluid at the passageway outlet is approximately equal to the temperature of the circulation fluid at the passageway inlet.

31. A method for making an exposure apparatus comprising the steps of providing a mover, the mover being cooled by the method of claim 30.

32. A method of making a wafer comprising the steps of providing a substrate and transferring an image to the substrate with the exposure apparatus made pursuant to claim 30.

33. A method of cooling a mover, the mover including a conductor and a fluid passageway that is positioned near the conductor, the method comprising the steps of:
directing a circulation fluid into a passageway inlet to the fluid passageway; and
controlling the pressure of the circulation fluid near a passageway outlet with a pressure control device.

34. The method of claim 33 wherein the step of directing a circulation fluid includes the step of directing a circulation fluid that is within approximately 1 degree Celsius of boiling at the passageway inlet.

35. The method of claim 33 wherein the step of controlling the pressure of the circulation fluid includes the step of controlling pressure so that the temperature of the circulation fluid at the passageway outlet is approximately equal to the temperature of the circulation fluid at the passageway inlet.

36. A method for making an exposure apparatus comprising the steps of providing a mover, the mover being cooled by the method of claim 33.

37. A method of making a wafer comprising the steps of providing a substrate and transferring an image to the substrate with the exposure apparatus made pursuant to claim 36.
